(19) United States
(12) Patent Application Publication
(10) Pub. No.: US 2021/0319561 A1
(43) Pub. Date: Oct. 14, 2021

(54) Image segmentation method and system for pavement disease based on deep learning

(71) Applicants: BeSTDR Infrastructure Hospital(Pingyu), Zhumadian (CN); SAFEKEY Engineering Technology (Zhengzhou), Ltd., Zhengzhou (CN)

(72) Inventors: Hongyuan Fang, Zhumadian (CN); Niannian Wang, Zhumadian (CN); Jiaxiu Dong, Zhumadian (CN); Duo Ma, Zhumadian (CN); Juan Zhang, Zhumadian (CN); Haobang Hu, Zhengzhou (CN); Gaozhao Pang, Zhengzhou (CN); Jianwei Lei, Zhengzhou (CN)

(21) Appl. No.: 17/356,526

(22) Filed: Jun. 24, 2021

(30) Foreign Application Priority Data
Nov. 2, 2020 (CN) 202011203796.2

(51) Int. Cl. G06T 7/11; G06T 7/00

(52) U.S. Cl. CPC G06T 7/11; G06T 2207/20081; G06T 7/0012

(57) ABSTRACT

An image segmentation method and system for a pavement disease based on deep learning are provided, relating to a field of image processing. The image segmentation method includes steps of: acquiring a pavement detection image; inputting the pavement detection image into a disease segmentation model which is obtained through training a deep learning network with a disease database; recognizing and segmenting the pavement disease, and obtaining a segmented image of the pavement disease. The image segmentation method adopts a deep learning algorithm for image segmentation, so that a pavement disease region is automatically obtained, a working efficiency is improved and meanwhile image segmentation becomes more accurate.

### CROSS REFERENCE OF RELATED APPLICATION

The application claims priority under 35 U.S.C. 119(a-d) to CN 202011203796.2, filed Nov. 2, 2020.

### BACKGROUND OF THE PRESENT INVENTION

### Field of Invention

The present invention relates to a technical field of image processing, and more particularly to an image segmentation method and system for a pavement disease based on deep learning.

### Description of Related Arts

In recent years, the highway construction in China has made remarkable achievements, and the highway traffic mileage increases rapidly. According to the “National Highway Network Planning (2013-2030)” and the requirements of highway construction planning tasks in each province, during the period of 13^{th} five-year plan, it is required to newly build 5,000 kilometers of expressway, newly rebuild 20,000 kilometers of secondary highway, and construct 50,000 kilometers of rural highway every year. However, whether the concrete pavement or the bituminous pavement, after being opened and used for a period of time, various defects such as damages and deformations successively occur due to design and construction factors, wherein fractures, cracks, and potholes are most common. How to rapidly and accurately find these hidden dangers at the early stage and repair it for avoiding the further deterioration of the structural performance has become the problem urgently to be solved in the field of road engineering maintenance.

Currently, there are mainly two methods for detecting the pavement disease. The first method adopts manual inspection, which mainly depends on the subjective judgment of people, causing the low detection precision and efficiency. The second method is based on computer vision; if a gray value of the disease is smaller than that of the background region, ways such as threshold segmentation and histogram segmentation are adopted; if a gray value of an edge of the disease region changes greatly, the way of edge detection is adopted; based on traditional machine learning, with the method such as random forest, Adaboost or SVM (Support Vector Machine), the disease features are extracted. Because of the inconsistent direction, irregular texture and non-uniform shape, these methods are difficult to completely count all of the features of the disease. Moreover, the pavement image itself contains a lot of noise; the brightness change, dust and driving speed all have the great influence on the detection results.

The Chinese patent application of CN201910604713.1 disclosed a pavement fracture segmentation and recognition method based on deep learning. According to the method, the acquired color fracture sample image is firstly annotated manually, and then a fracture label image is obtained; two types of images are respectively segmented with the same size and location, and whether the sub-image contains the fracture is annotated; the U-Net neural network is trained with the annotated sub-image; the results of last two layers of the U-Net neural network are adopted as the input of the decision network, for training the decision network; finally, the trained network model is obtained, and the images to be recognized are detected and classified with the non-overlapping sliding windows, so as to obtain the image segmentation and recognition results. However, the existing problems are still not effectively solved.

Thus, there still exist deficiencies in the conventional pavement disease recognition technology, which needs to be improved.

### SUMMARY OF THE PRESENT INVENTION

In view of above deficiencies in the prior art, an object of the present invention is to provide an image segmentation method and system for a pavement disease based on deep learning, which are constituted based on a deep learning algorithm.

In order to accomplish the above object, the present invention adopts technical solutions as follows.

An image segmentation method for a pavement disease based on deep learning comprises steps of:

acquiring a pavement detection image; and inputting the pavement detection image into a disease segmentation model which is obtained through training a deep learning network with a disease database; and recognizing and segmenting the pavement disease, and obtaining a segmented image of the pavement disease.

Preferably, the disease segmentation model is obtained through steps of:

acquiring pavement disease images, then pre-processing and annotating, and forming pavement disease image databases; and dividing the pavement disease image databases into a training set and a testing set;

building the deep learning network, and training the deep learning network with the training set; and

testing a trained deep learning model with the testing set, and outputting a deep learning network meeting a testing standard as the disease segmentation model.

Preferably, the steps of pre-processing and annotating specifically comprise steps of:

cropping each pavement disease image into an image of a predetermined pixel size;

enhancing data through mirroring, rotating and adding Gaussian noise; and

annotating a disease in each image, and respectively building different pavement disease image databases according to disease types.

Preferably, training of the deep learning network comprises a forward propagation operation, specifically comprising steps of:

extracting features from each image, and forming an extracted feature map;

sliding in the extracted feature map with anchors of different ratios and different scales, and obtaining candidate regions; removing redundant candidate regions with a non-maximum suppression (NMS) algorithm, and obtaining a candidate feature map;

with a bilinear interpolation algorithm, completing mapping between the candidate feature map and a target region in a training image; correcting a boundary of the candidate feature map, and obtaining a pre-segmented disease image; and determining an error loss value between the pre-segmented disease image and the target region in the training image; and according to the error loss value, adjusting network parameters of the deep learning network.

Preferably, the testing standard is that: the error loss value is smaller than a preset loss value, or training times reach a maximum value of iteration times.

Preferably, training of the deep learning network further comprises a back propagation operation, which is processed with a stochastic gradient descent algorithm.

Preferably, the image segmentation method further comprises a disease measurement operation, specifically comprising steps of:

acquiring image data of a reference object under same shooting conditions, and obtaining a unit pixel size; and

obtaining measured data of the segmented image of the pavement disease.

An image segmentation system for the pavement disease based on deep learning with the image segmentation method is further provided, comprising a mobile terminal and an analysis terminal, which are able to perform data interaction, wherein: the disease segmentation model is stored in the analysis terminal;

the mobile terminal comprises an image acquisition module, a data interaction module, a locating module, and an integration module;

the image acquisition module is for acquiring the pavement detection image;

the data interaction module is for uploading the pavement detection image to the analysis terminal and receiving classification and segmentation results from the analysis terminal;

the locating module is for acquiring locating data; and

the integration module is for integrating the classification and segmentation results with the locating data and building a pavement disease information database, so as to realize human-computer interaction.

Preferably, the image acquisition module is a high-precision camera.

A computer readable medium is further provided, in which a computer software is stored, wherein: when the computer software is executed by a processor, the image segmentation method for the pavement disease based on deep learning is implemented.

Compared with the prior art, the image segmentation method and system for the pavement disease based on deep learning, provided by the present invention, have following beneficial effects.

(1) The image segmentation method provided by the present invention adopts the deep learning algorithm for image segmentation, so that the pavement disease region is automatically obtained, the working efficiency is improved and meanwhile image segmentation becomes more accurate.

(2) According to the image segmentation method provided by the present invention, various ways such as flipping, translating, cropping, and adding the Gaussian noise are used in image segmentation for enhancing data, which is beneficial to improving the generalization ability and the robustness of the model.

(3) According to the image segmentation method provided by the present invention, the pixel-level intelligent segmentation network for various pavement diseases based on Mask R-CNN is built, which adopts ResNet101 and combines with the feature pyramid network (FPN), so that the low-level features with high resolution and low-level semantic meaning and the high-level features with low resolution and high-level semantic meaning are fused, thereby containing more semantic information; therefore, not only the detection efficiency of the model is ensured, but also the detection accuracy is improved.

(4) The image segmentation system provided by the present invention designs and develops the mobile terminal, and realizes real-time human-computer interaction through the image acquisition module, the data interaction module, the locating module, and the integration module.

### BRIEF DESCRIPTION OF THE DRAWINGS

FIG. 1 is a flow chart of an image segmentation method for a pavement disease based on deep learning according to a preferred embodiment of the present invention.

FIG. 2 is a flow chart of obtaining a disease segmentation model according to the preferred embodiment of the present invention.

FIG. 3 is a flow chart of pre-processing and annotating operations according to the preferred embodiment of the present invention.

FIG. 4 is a flow chart of a forward propagation operation in training of a deep learning network according to the preferred embodiment of the present invention.

FIG. 5 is a flow chart of a disease measurement operation according to the preferred embodiment of the present invention.

FIG. 6 is a structural block diagram of a Mask R-CNN network according to the preferred embodiment of the present invention.

FIG. 7 is a structural block diagram of an image segmentation system for the pavement disease according to the preferred embodiment of the present invention.

FIG. 8 is a structural block diagram of a mobile terminal according to the preferred embodiment of the present invention.

### DETAILED DESCRIPTION OF THE PREFERRED EMBODIMENT

In order to make objects, technical solutions and effects of the present invention clearer, the present invention is further described in detail with the accompanying drawings and the preferred embodiment as follows. It should be understood that the preferred embodiment described herein is only for explaining the present invention, not for limiting the present invention.

One of ordinary skill in the art should understand that: the foregoing general description and the following detailed description are exemplary and illustrative embodiments of the present invention, not intended for limiting the present invention.

The terms such as “comprise”, “include” and any other variant thereof in the present invention is non-exclusive; that is to say, the process or method can not only comprise the listed steps, but also comprise other steps which are not clearly listed or inherent steps of the process or method. Similarly, under a condition that there are no more limitations, one or more devices, sub-systems, elements, structures or components started with “comprise . . . one” also do not have more limitations, indicating that other devices, sub-systems, elements, structures or components are not excluded. In the whole specification, phrases such as “in one embodiment”, “in another embodiment” and similar expressions do not always refer to the same embodiment.

Unless otherwise defined, all of the technical and scientific terms used in the present invention have the same meaning as generally understood by one of ordinary skill in the art.

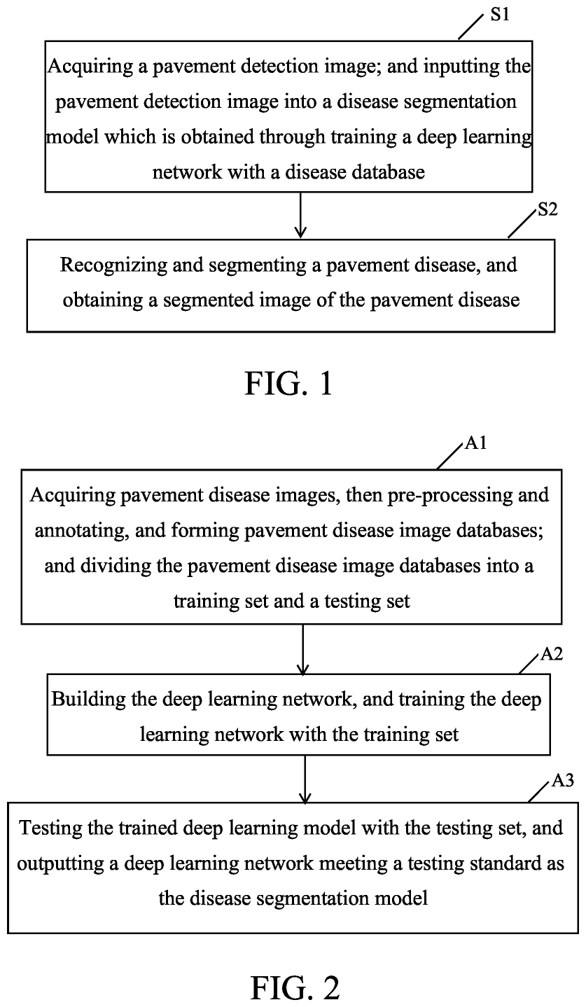

Referring to FIG. 1, according to the preferred embodiment of the present invention, an image segmentation method for a pavement disease based on deep learning is provided, comprising steps of:

(S1) acquiring a pavement detection image, wherein: the acquired pavement detection image can be an image taken at the scene, and can also be an image in a gallery, which needs disease segmentation and recognition; a source of the pavement detection image is not limited herein; it is preferred that the pavement detection image is shot by a high-definition camera; pixel specifications of photos shot by the high-definition camera comprise 1024*720, 1600*1200, 1920*1080 and 2304*1728, so as to ensure definition of the acquired pavement detection image;

inputting the pavement detection image into a disease segmentation model which is obtained through training a deep learning network with a disease database, wherein: the deep learning network is preferred to be a Mask R-CNN network; the disease segmentation model is obtained in a server or a specific device in advance, not obtained in this step through training; a detailed training process can be a common training method in the art; referring to FIG. 2, a training process of the disease segmentation model is provided; the disease segmentation model is obtained through steps of:

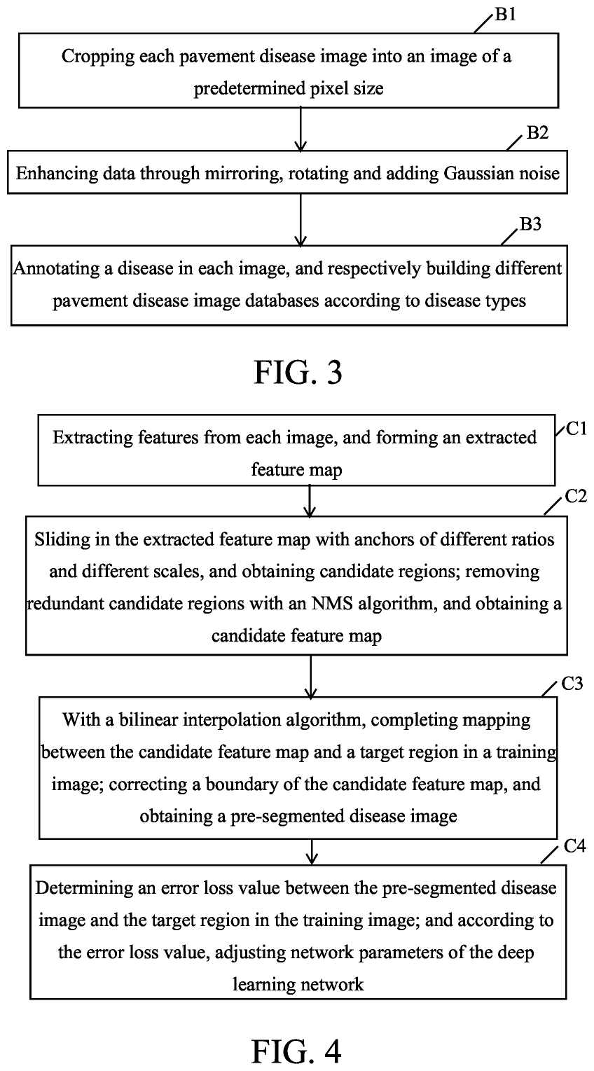

(A1) acquiring pavement disease images, then pre-processing and annotating, and forming pavement disease image databases; and dividing the pavement disease image databases into a training set and a testing set; wherein: the pavement disease images can be images actually shot by the high-definition camera, and can also be pavement images which are selected from a gallery and reach the certain pixel specifications; referring to FIG. 3, in the preferred embodiment, the steps of pre-processing and annotating specifically comprise steps of:

(B1) cropping each pavement disease image into an image of a predetermined pixel size;

(B2) enhancing data through mirroring, rotating and adding Gaussian noise; and

(B3) annotating a disease in each image, and respectively building different pavement disease image databases according to disease types;

wherein: generally, the pavement disease images comprise three types of diseases, respectively fractures, cracks, and potholes; the step of pre-processing comprises batch cropping of image sizes and data enhancing, and thereafter data annotating is conducted, so as to form a large database of the pavement disease images, for training and testing the built deep learning model; a cropping size of each pavement disease image is preferred to be 512*512 pixels; actually, each pavement disease image can also be cropped into a pixel size of 256*256, which is not limited by the present invention; data enhancing technologies comprise mirroring, rotating and adding the Gaussian noise, which is beneficial to improving a generalization ability and a robustness of the model; the step of annotating is to annotate a disease region in each image; particularly, in the preferred embodiment, an open source labelme software is used; according to the disease types, in each image, a background region is annotated as “0”, a fracture region is annotated as “1”, a crack region is annotated as “2”, and a pothole region is annotated as “3”; the data obtained after annotating each image are randomly divided with a proportion of 4:1, respectively denoted as the training set and the testing set; 80% of the data, namely the training set, are used to train the Mask R-CNN network for achieving a better learning and training effect, thereby improving precision of the model; 20% of the data, namely the testing set, are used to test the Mask R-CNN network, for testing the precision of the model;

(A2) building the deep learning network, and training the deep learning network with the training set, wherein: referring to FIG. 6, the deep learning network is preferred to be the Mask R-CNN network; in the preferred embodiment, the Mask R-CNN network comprises a convolutional network, a region proposal network (RPN), a RolAlign module, and a classification and segmentation network; the convolutional network adopts ResNet101 and combines with a feature pyramid network (FPN) for feature extraction, so that low-level features with high resolution and low-level semantic meaning and high-level features with low resolution and high-level semantic meaning are fused, thereby containing more semantic information; therefore, not only a detection efficiency of the model is ensured, but also a detection accuracy is improved; ResNet101 comprises five convolutional modules; the RPN is preferred to adopt scales of 64×64, 128×128 and 256×256 and aspect ratios of 1:1, 1:2 and 2:1 for extracting candidate regions, so that the RPN is applicable to damaged regions of different sizes and shapes; meanwhile, redundant candidate regions are removed with a non-maximum suppression (NMS) algorithm, so that detection efficiency and accuracy of the model are improved; in the preferred embodiment, the RolAlign module cancels a rounding operation of RoI Pooling, allows an existence of floating-point numbers, and uses a bilinear interpolation algorithm to accurately complete mapping between a candidate feature map and a target region, thereby effectively improving the detection accuracy of the model; the classification and segmentation network is preferred to adopt bounding-box regression to realize correction of bounding boxes of the candidate regions, use a classification branch to realize classification of the pavement diseases, and output a prediction mask of each type of diseases in a Mask Branch, so as to realize pixel-level segmentation of multiple pavement diseases; and

(A3) testing the trained deep learning model with the testing set, and outputting a deep learning network meeting a testing standard as the disease segmentation model;

wherein: referring to FIG. 4, in the preferred embodiment, training of the deep learning network comprises a forward propagation operation, specifically comprising steps of:

(C1) extracting features from each image, and forming an extracted feature map;

(C2) sliding in the extracted feature map with anchors of different ratios and different scales, and obtaining the candidate regions; removing the redundant candidate regions with the NMS algorithm, and obtaining the candidate feature map;

(C3) with the bilinear interpolation algorithm, completing mapping between the candidate feature map and a target region in a training image; correcting a boundary of the candidate feature map, and obtaining a pre-segmented disease image; and

(C4) determining an error loss value between the pre-segmented disease image and the target region in the training image; and according to the error loss value, adjusting network parameters of the deep learning network;

wherein: during image processing, a positive training (which is also an operation of image segmentation) of the Mask R-CNN network comprises steps of:

(2.1) by the convolutional network, adopting ResNet101 and combining with the FPN for feature extraction, wherein ResNet101 comprises five convolutional modules;

(2.2) by the RPN, adopting the anchors of different ratios and different scales to slide in the extracted feature map, and obtaining the candidate regions; and removing the redundant candidate regions with the NMS algorithm;

(2.3) by the RolAlign module, canceling the rounding operation of RoI Pooling, allowing the existence of the floating-point numbers, and using the bilinear interpolation algorithm to accurately complete mapping between the candidate feature map and the target region; and

(2.4) by the classification and segmentation network, realizing correction of the bounding boxes of the candidate regions with bounding-box regression, using the classification branch to realize classification of the pavement diseases, and outputting the prediction mask of each type of diseases in the Mask Branch, so as to realize pixel-level segmentation of multiple pavement diseases;

wherein: in the preferred embodiment, the testing standard is that: the error loss value is smaller than a preset loss value, or training times reach a maximum value of iteration times;

in the preferred embodiment, training of the deep learning network further comprises a back propagation operation, which is processed with a stochastic gradient descent algorithm, specifically comprising steps of:

(3.1) setting model hyper-parameters such as an initial learning rate, iteration times, a weight decay and a momentum, and then training; and

(3.2) calculating an error loss value between an actual output and a target output of the model; if the error loss value is smaller than a preset loss value, generating the disease segmentation model; otherwise, returning back to the step 3.1;

(S2) recognizing and segmenting the pavement disease, and obtaining a segmented image of the pavement disease;

wherein: a segmentation process of the pavement disease is consistent with the above steps of extracting the pre-segmented disease image in training, which is not limited in the present invention, comprising steps of: extracting features from the image, and forming the extracted feature map; sliding in the extracted feature map with the anchors of different ratios and different scales, and obtaining the candidate regions; removing the redundant candidate regions with the NMS algorithm, and obtaining the candidate feature map; with the bilinear interpolation algorithm, completing mapping between the candidate feature map and the target region in the training image; correcting the boundary of the candidate feature map, and obtaining the segmented image of the pavement disease.

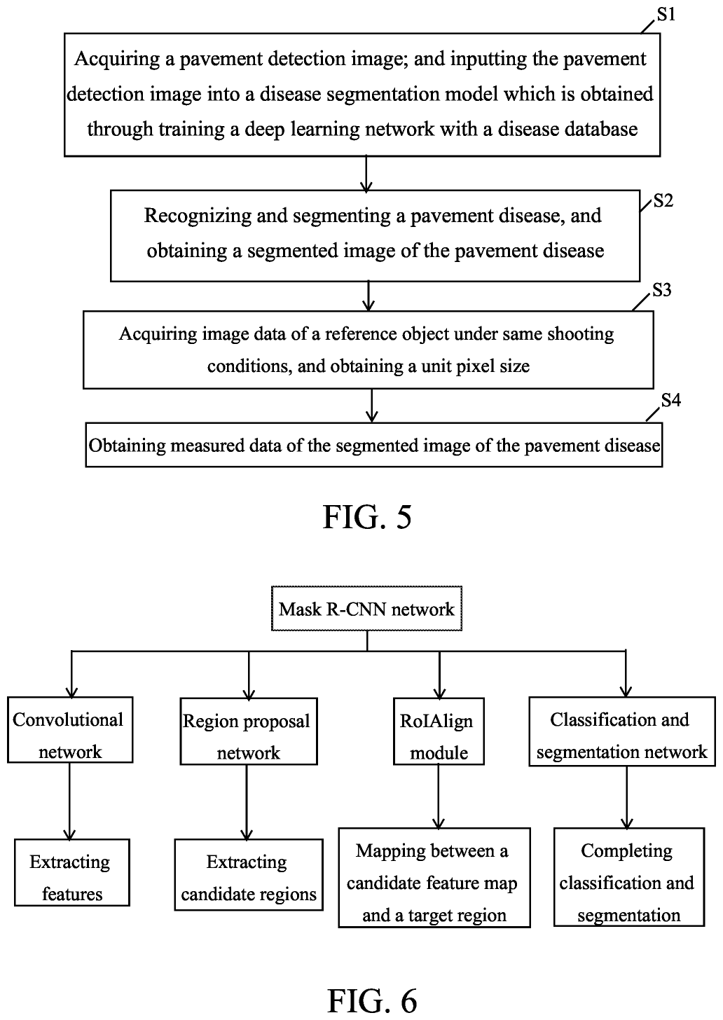

Furthermore, referring to FIG. 5, according to the preferred embodiment of the present invention, the image segmentation method further comprises a disease measurement operation, specifically comprising steps of:

(S3) acquiring image data of a reference object under same shooting conditions, and obtaining a unit pixel size; and

(S4) obtaining measured data of the segmented image of the pavement disease;

wherein: firstly, a reference (such as a 0.5-yuan coin) image under the same shooting conditions (such as a shooting distance, a photo-sensibility, a focal length and a resolution) as the pavement disease data is processed; for example, an actual size of the 0.5-yuan coin is known, then a pixel value corresponding to the diameter is measured and an actual size of the unit pixel is calculated, and an actual size of the pavement disease is calculated specifically through steps of: based on the segmented image of the pavement disease generated through the deep learning algorithm, extracting topological information of the pavement disease; constructing calculation formulas of length, width and area of the pavement disease, conducting pixel-level size measurement for the disease region of the disease topological structure according to the formulas, and calculating the actual size information of the disease region; based on the actual size measurement results of the pavement diseases, the pavement diseases of different damage degrees can be classified; for example, the pavement disease with the low damage degree is treated later, while the pavement disease with the high damage degree is treated preferentially; distinguishing of the damage degrees can be determined according to sizes of the diseases or other parameters; different judgement standards are used for different disease types.

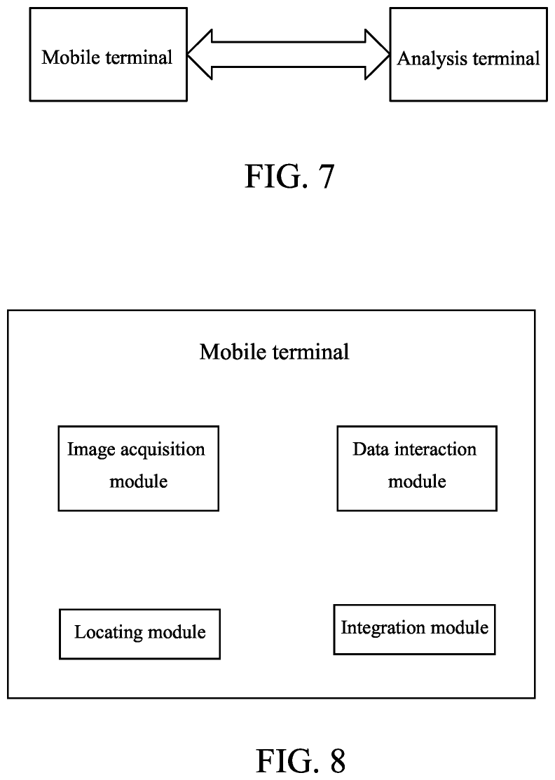

Referring to FIGS. 7-8, according to the preferred embodiment of the present invention, an image segmentation system for the pavement disease based on deep learning with the image segmentation method is further provided, comprising a mobile terminal and an analysis terminal, which are able to perform data interaction, wherein: the disease segmentation model is stored in the analysis terminal; connection between the mobile terminal and the analysis terminal can be wireless connection, wired connection, network remote connection, or near-end wireless/wired connection.

The mobile terminal comprises an image acquisition module, a data interaction module, a locating module, and an integration module, wherein:

the image acquisition module is for acquiring the pavement detection image;

the data interaction module is for uploading the pavement detection image to the analysis terminal and receiving classification and segmentation results from the analysis terminal;

the locating module is for acquiring locating data; and

the integration module is for integrating the classification and segmentation results with the locating data and building a pavement disease information database, so as to realize human-computer interaction.

In the preferred embodiment, the image acquisition module is a high-precision camera; the pavement detection image is shot by the high-definition camera; pixel specifications of photos shot by the high-definition camera comprise 1024*720, 1600*1200, 1920*1080 and 2304*1728, so as to ensure definition of the acquired pavement detection image.

Specifically, the image acquisition module is for shooting and acquiring the pavement detection image at the scene in real-time; the data interaction module uploads the pavement detection image which is shot in real-time or stored locally to the analysis terminal and a server terminal for detection and segmentation, and meanwhile transmits the disease detection and segmentation results to the mobile terminal in real-time for real-time display; the locating module is preferred to be a GPS module, for locating a disease location, which can display longitude and latitude information of the disease in real-time and is beneficial for maintenance personnel to determine and repair the disease in time; the integration module integrates the returned segmented disease information with the GPS locating information and builds the pavement disease information database, so as to realize better human-computer interaction.

When the mobile terminal builds internal software components, the used technologies comprise an OKHTTP framework, a GSON framework and a RecyclerView framework. HTTP is a common network way for exchanging data and media; efficient utilization of HTTP makes resource loading faster and saves the bandwidth. OKHTTP is an efficient HTTP client; through building the OKHTTP framework, Android applications can access the server in multiple threads to acquire data, and data of thousands of MB can be downloaded in milliseconds. The GSON framework operates the interconversion between the object and the j son data; when receiving the j son file from the server, the data are converted to an environment applicable to the mobile terminal, which makes parsing of the server data convenient. The RecyclerView framework optimizes various deficiencies in a built-in control ListView of the mobile terminal. With the above technologies, vertical and horizontal scrolling of the data are realized; the invisible data are released to store the data to be visible; the operation speed of the mobile terminal is improved, so that the image can be loaded faster; and the GPS module is introduced to display the longitude and latitude information of the pavement disease.

Furthermore, the present invention further provides a computer readable medium, in which a computer software is stored, wherein: when the computer software is executed by the processor, the image segmentation method for the pavement disease based on deep learning is implemented. Specifically, the readable medium can exist independently or depending on the general electronic device, as long as the software can be executed by the processor to realize corresponding function operations.

It should be understood that: equivalent replacements or modifications can be made by one of ordinary skill in the art according to the technical solutions and inventive concepts of the present invention; these modifications or replacements are all encompassed in the protection scope of the claims of the present invention.

What is claimed is:

1. An image segmentation method for a pavement disease based on deep learning, comprising steps of:
acquiring a pavement detection image; and inputting the pavement detection image into a disease segmentation model which is obtained through training a deep learning network with a disease database; and
recognizing and segmenting the pavement disease, and obtaining a segmented image of the pavement disease.

2. The image segmentation method, as recited in claim 1, wherein the disease segmentation model is obtained through steps of:
acquiring pavement disease images, then pre-processing and annotating, and forming pavement disease image databases; and dividing the pavement disease image databases into a training set and a testing set;
building the deep learning network, and training the deep learning network with the training set; and
testing a trained deep learning model with the testing set, and outputting a deep learning network meeting a testing standard as the disease segmentation model.

3. The image segmentation method, as recited in claim 2, wherein the steps of pre-processing and annotating specifically comprise steps of:
cropping each pavement disease image into an image of a predetermined pixel size;
enhancing data through mirroring, rotating and adding Gaussian noise; and
annotating a disease in each image, and respectively building different pavement disease image databases according to disease types.

4. The image segmentation method, as recited in claim 2, wherein training of the deep learning network comprises a forward propagation operation, specifically comprising steps of:
extracting features from each image, and forming an extracted feature map;
sliding in the extracted feature map with anchors of different ratios and different scales, and obtaining candidate regions; removing redundant candidate regions with a non-maximum suppression (NMS) algorithm, and obtaining a candidate feature map;
with a bilinear interpolation algorithm, completing mapping between the candidate feature map and a target region in a training image; correcting a boundary of the candidate feature map, and obtaining a pre-segmented disease image; and
determining an error loss value between the pre-segmented disease image and the target region in the training image; and according to the error loss value, adjusting network parameters of the deep learning network.

5. The image segmentation method, as recited in claim 4, wherein the testing standard is that: the error loss value is smaller than a preset loss value, or training times reach a maximum value of iteration times.

6. The image segmentation method, as recited in claim 4, wherein: training of the deep learning network further comprises a back propagation operation, which is processed with a stochastic gradient descent algorithm.

7. The image segmentation method, as recited in claim 1, further comprising a disease measurement operation, specifically comprising steps of:
acquiring image data of a reference object under same shooting conditions, and obtaining a unit pixel size; and
obtaining measured data of the segmented image of the pavement disease.

8. An image segmentation system for the pavement disease based on deep learning with the image segmentation method as recited in claim 1, comprising a mobile terminal and an analysis terminal, which are able to perform data interaction, wherein: the disease segmentation model is stored in the analysis terminal;
the mobile terminal comprises an image acquisition module, a data interaction module, a locating module, and an integration module;
the image acquisition module is for acquiring the pavement detection image;
the data interaction module is for uploading the pavement detection image to the analysis terminal and receiving classification and segmentation results from the analysis terminal;
the locating module is for acquiring locating data; and
the integration module is for integrating the classification and segmentation results with the locating data and building a pavement disease information database, so as to realize human-computer interaction.

9. The image segmentation system, as recited in claim 8, wherein the image acquisition module is a high-precision camera.

10. A computer readable medium, in which a computer software is stored, wherein: when the computer software is executed by a processor, the image segmentation method for the pavement disease based on deep learning as recited in claim 1 is implemented.
